(19) United States
(12) Patent Application Publication
(10) Pub. No.: US 2025/0291526 A1
(43) Pub. Date: Sep. 18, 2025

(54) AUTOMATIC INSPECTION TEMPLATE GENERATION MECHANISM

(71) Applicants: Danish Ahmed, Boulder, CO (US); Scott R. Johnson, Boulder, CO (US); Farnaz HajiahmadiFoomani, Milwaukee, WI (US); Ziling Zhang, Boulder, CO (US)

(72) Inventors: Danish Ahmed, Boulder, CO (US); Scott R. Johnson, Boulder, CO (US); Farnaz HajiahmadiFoomani, Milwaukee, WI (US); Ziling Zhang, Boulder, CO (US)

(73) Assignee: Ricoh Company, Ltd., Tokyo (JP)

(21) Appl. No.: 18/608,125

(22) Filed: Mar. 18, 2024

(51) Int. Cl. G06F 3/12

(52) U.S. Cl. CPC G06F 3/1208; G06F 3/1257; G06F 3/1279

(57) ABSTRACT

A system is disclosed. The system includes at least one physical memory device to store inspection logic and one or more processors coupled with the at least one physical memory device to execute the inspection logic to receive one or more page images of a processed print job, analyze the page images to identify print objects and determine corresponding inspection regions in the corresponding page images at which the print objects are located and generate an inspection template including the inspection regions, wherein the inspection regions comprise regions to be inspected during document inspection of the printed print job.

### FIELD OF THE INVENTION

The invention relates to the field of printing systems, and in particular, to image processing in a printing system.

### BACKGROUND

High speed print production systems often implement a print verification (or inspection) system to detect defects in print data applied to a medium (e.g., paper). Print defects most often result from impurities included in the medium, or from partial drying and clumping of ink at the mouth of print nozzles. While some defects are acceptable, others cause printed matter to be rejected and destroyed.

### SUMMARY

In one embodiment, a system includes at least one physical memory device to store inspection logic and one or more processors coupled with the at least one physical memory device to execute the inspection logic to receive one or more page images of a processed print job, analyze the page images to identify print objects and determine corresponding inspection regions in the corresponding page images at which the print objects are located and generate an inspection template including the inspection regions, wherein the inspection regions comprise regions to be inspected during document inspection of the printed print job.

### BRIEF DESCRIPTION OF THE DRAWINGS

A better understanding of the present invention can be obtained from the following detailed description in conjunction with the following drawings, in which:

FIG. 1 is a block diagram of one embodiment of a printing system;

FIGS. 2A&2B are block diagrams illustrating embodiment of a print controller;

FIG. 3 is a flow diagram illustrating a conventional process for generating inspection templates;

FIG. 4 illustrates one embodiment of an inspection template generation module;

FIG. 5 illustrates one embodiment of a process for determining page similarity;

FIG. 6 illustrates one embodiment of template generation logic;

FIGS. 7A & 7B is a flow diagram illustrating one embodiment of a process for generating an inspection template;

FIG. 8 illustrates one embodiment of template processing logic;

FIG. 9 is a flow diagram illustrating one embodiment of a process for evaluating a region of interest;

FIG. 10 is a flow diagram illustrating one embodiment of a process for processing a generated template;

FIG. 11 is a flow diagram illustrating embodiments of a process for generating an inspection production;

FIG. 12A illustrates one embodiment of a print job;

FIG. 12B illustrates one embodiment of a correspondence between page image elements and inspection template elements; and

FIG. 13 illustrates one embodiment of a computer system.

### DETAILED DESCRIPTION

A mechanism for automatically generating inspection templates is described. In the following description, for the purposes of explanation, numerous specific details are set forth to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Throughout this document, terms like “logic”, “component”, “module”, “engine”, “model”, “calculator”, and the like, may be referenced interchangeably and include, by way of example, software, hardware, and/or any combination of software and hardware, such as firmware. Further, any use of a particular brand, word, term, phrase, name, and/or acronym, should not be read to limit embodiments to software or devices that carry that label in products or in literature external to this document.

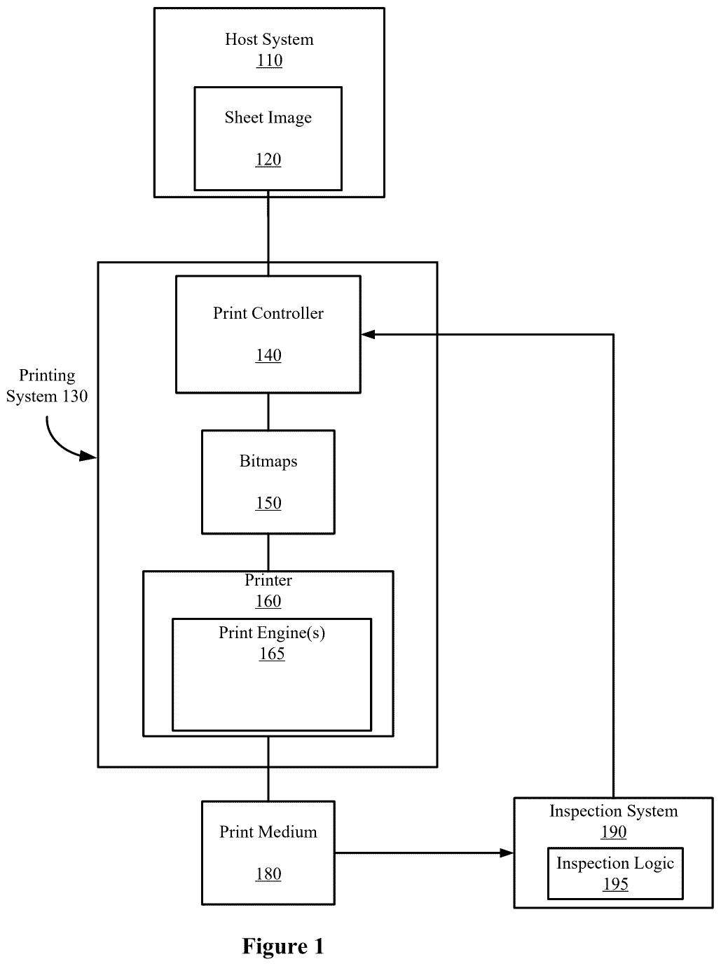

FIG. 1 is a block diagram illustrating one embodiment of a printing system 130. A host system 110 is in communication with the printing system 130 to print a sheet image 120 onto a print medium 180 (e.g., paper) via a printer 160. The resulting print medium 180 may be printed in color and/or in any of a number of gray shades, including black and white (e.g., Cyan, Magenta, Yellow, and blacK, (CMYK)). The host system 110 may include any computing device, such as a personal computer, a server, cloud infrastructure, or even a digital imaging device, such as a digital camera or a scanner.

The sheet image 120 may be any file or data that describes how an image on a sheet of print medium 180 should be printed. For example, the sheet image 120 may include PostScript data, Printer Command Language (PCL) data, and/or any other printer language data. The print controller 140 processes the sheet image to generate a bitmap 150 for printing to the print medium 180 via the printer 160.

The printing system 130 may be a high-speed printer operable to print relatively high volumes (e.g., greater than 100 pages per minute). The print medium 180 may be continuous form paper, cut sheet paper, and/or any other tangible medium suitable for printing. The printing system 130, in one generalized form, includes the printer 160 having one or more print engines 165 to present the bitmap 150 onto the print medium 180 via marking material (e.g., toner, ink, coatings, etc.) based on the sheet image 120.

Print controller 140 and printer 160 may be both implemented in the same printing system 130 or implemented separately and coupled together. In another embodiment, print controller 140 may be implemented in host system 110 and coupled to printer 160. Print controller 140 may be any system, device, software, circuitry and/or other suitable component operable to transform the sheet image 120 for generating the bitmap 150 in accordance with printing onto the print medium 180. In this regard, the print controller 140 may include processing and data storage capabilities.

In one embodiment, inspection system 190 is implemented to capture images of the printed surfaces of print medium 180 and determine print quality defects on the print medium 180 (e.g., substrate or print substrate). Inspection system 190 may capture images with a camera, scanner or other imaging device. Print quality defects may be defects from faulty print marking on the substrate (e.g., missing ink drops such as due to clogged ink nozzles, ink drops not in the correct location on the substrate, incorrect colors, incorrect characters, incorrect images, incorrect bar code data encoding, bar code quality, and/or incorrect image element sizes) and/or physical defects in the substrate (e.g., impurities, spots, stains, flutter, cockle, wrinkles and/or z-direction defects). In one embodiment, inspection system 190 may report results of any detected defects to print controller 140 for further processing. Inspection system 190 may be a stand-alone component or may be integrated into the printing system 130.

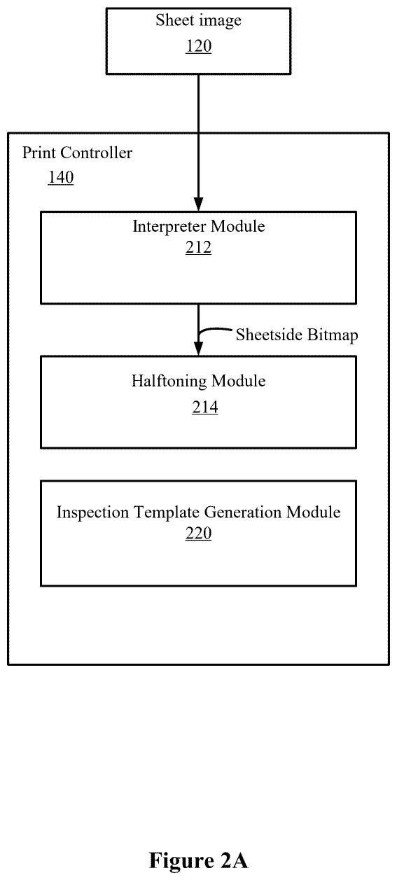

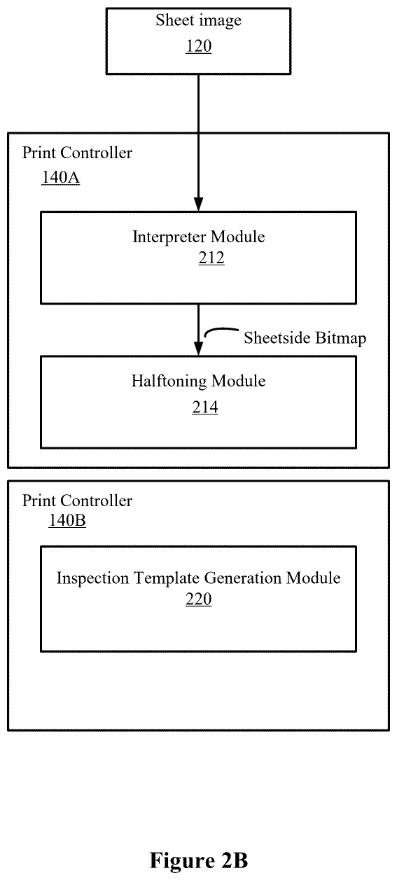

FIG. 2A & FIG. 2B illustrate embodiments of a print controller 140. As shown in FIG. 2A, print controller 140 (e.g., DFE or digital front end), in its generalized form, includes interpreter module 212, halftoning module 214 and inspection template generation module 220. FIG. 2B illustrates an alternative embodiment having print controllers 140A&140B. In this embodiment, print controller 140A includes interpreter module 212 and halftoning module 214, while print controller 140B includes inspection template generation module 220. Print controllers 140A and 140B may be implemented in the same printing system 130 (as shown) or may be implemented separately and coupled together.

Interpreter module 212 is operable to interpret, render, rasterize, or otherwise convert images (e.g., raw sheetside images such as sheet image 120) of a print job into sheetside bitmaps. The sheetside bitmaps generated by interpreter module 212 are each a 2-dimensional array of pixels representing an image of the print job (e.g., a Continuous Tone Image (CTI)), also referred to as full sheetside bitmaps. The 2-dimensional pixel arrays are considered “full” sheetside bitmaps because the bitmaps include the set of pixels for the image. In one embodiment, interpreter module 212 is operable to interpret or render multiple raw sheetsides concurrently so that the rate of rendering substantially matches the rate of imaging of production print engines.

Halftoning module 214 is operable to represent the sheetside bitmaps as halftone patterns of ink. For example, halftoning module 214 may convert the pixels to halftone patterns of CMYK ink for application to the paper. A halftone design may comprise a pre-defined mapping of input pixel gray levels to output drop sizes based on pixel location.

Print production at printing system 130 is increasingly moving towards increased production complexity and throughput with less print system operator intervention. This includes features such as including additional dynamic data within print jobs and variability in forms and page sizes, added ability for finishing equipment, workflow solutions to manage such features and print inspection to verify the output results. All of this is desired to be done without stopping the printing process. However, conventional systems have limitations as to how inspection templates are generated for use by an inspection system 190 to inspect printed jobs for print quality defects.

An inspection template comprises a page level instruction set that includes regions of interests (ROIs) to examine at an inspection system for a specific quality feature at a specific location within a printed image. An inspection production comprises an instruction set including a plurality of inspection templates. Conventional inspection template generation process involves the manual setup of regions and inspection regions in a template. In this scenario an operator loads a print job for printing on a printer with the required paper. The operator then generates a new, or copies existing, inspection template.

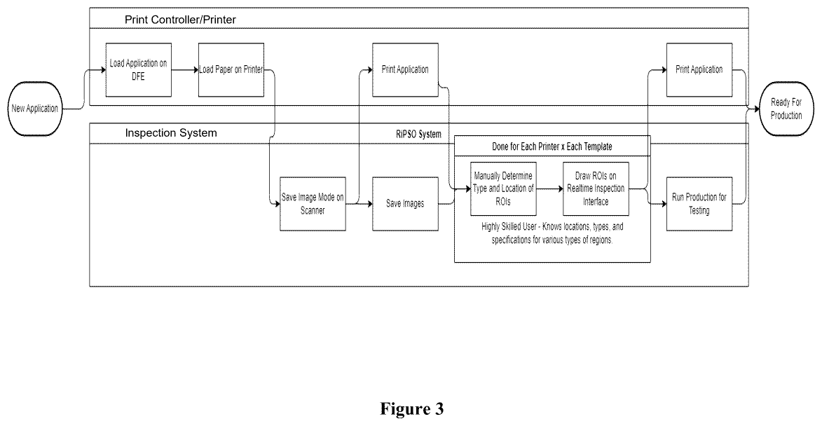

Subsequently the operator must configure the inspection system by taking steps to save representative sample images, identifying inspection regions in the print job, and take into account details regarding consistency and frequency of regions throughout the print job, print object types, barcode type, OCR value, etc. Additionally, the operator must define inspection types and draw regions based on the sample images, and finally re-print the print job to validate and adjust the inspection criteria. FIG. 3 is a flow diagram illustrating the conventional process for generating inspection templates. The above-described process may take a skilled operator several hours to complete for each job that is to be printed.

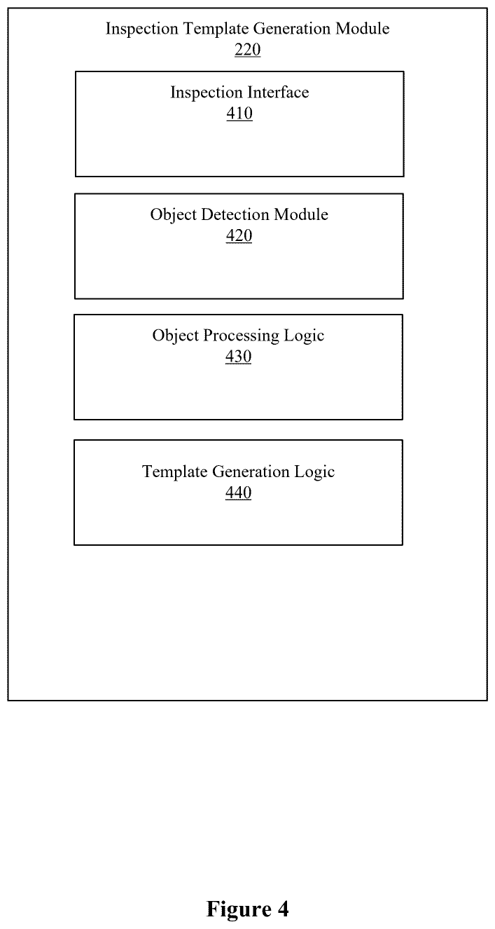

According to one embodiment, inspection template generation module (or template generation module) 220 is provided to identify and segment regions within a print job where inspection items occur and automatically generate an inspection template to use with the print job. The technical benefits for automatically generating an inspection template include more efficiency, improved accuracy and less print operator intervention. FIG. 4 illustrates one embodiment of a template generation module 220. In one embodiment, template generation module 220 is provided to receive one or more page images of a processed print job, analyze the page images to identify print objects and determine corresponding inspection regions in the corresponding page images at which the print objects are located and generate an inspection template including the inspection regions to be inspected during document inspection of the printed print job. Page images may comprise bitmap image data (e.g., received from interpreter 212) or captured page images generated from imaging the print data printed on a print medium. Further, inspection regions comprise a subset of a page image.

As shown in FIG. 4, template generation module 220 includes an inspection interface 410 that comprises an application programming interface (API) that facilitates communication with inspection logic 195 at inspection system 190. According to one embodiment, inspection interface 410 is configured to transmit inspection productions including a plurality of inspection templates to inspection system 190.

In a further embodiment, inspection interface 410 generates a production identifier associated with each production generated for a corresponding print job being processed at template generation module 220. In such an embodiment, the production identifier is provided to inspection logic 195 to enable inspection logic 195 to distinguish between different inspection productions in instances in which multiple inspection productions are provided to inspection logic 195 prior to inspection of multiple print jobs. In yet a further embodiment, inspection interface 410 generates a page identifier associated with each sheet image in the print job received for template generation.

Template generation module 220 also includes an object detection module 420. Object detection module 420 receives page images (e.g., from halftoning module 240) and analyzes the page images to identify print objects and determine inspection regions associated with the identified print objects. In one embodiment, the received page images comprise low resolution bitmap images that provide a simulation of a series of the print job images. In a further embodiment, object detection module 420 implements a trained neural network print object detection model and/or conventional logic to analyze the page images. A technical benefit from implementing a trained neural network to analyze page images as a part of generating inspection templates is increased computational efficiency and accuracy. In such an embodiment, object detection module 420 comprises a customized you only look once (YOLO) object detection model to determine boundaries of one or more inspection regions (e.g., including coordinates within corresponding page images) within corresponding page images. A technical benefit resulting from determining inspection regions, boundaries and/or coordinates for inclusion in an inspection template is improving the inspection template's location information and accuracy. In a further embodiment, object detection module 420 identifies one of a plurality of print object types for each of the identified print objects. In this embodiment, object types comprise logo objects and barcode objects. Additionally, other types of objects may be identified. For example, object types may also comprise optical character recognition (OCR) patterns (e.g., to validate items in the print, such as MICR line values or addresses) and control marks (e.g., too maintain color accuracy). A technical benefit resulting from identifying print object types for inclusion in an inspection template is improving inspection location's details and accuracy. Object detection module 420 generates inspection region data that comprises associated region identifier, associated print object type, and boundaries.

In one embodiment, the YOLO model first detects the regions of interest. YOLO is a deep neural network (DNN) based on ResNet50 that learns the coordinates of the objects (e.g., the center of the object and the width/height) upon detecting the inspection regions. Subsequently, a page image is processed by a series of Convolutional Neural Networks (CNNs) that learn the patterns in the objects and determines the coordinates of the objects.

In a further embodiment, object detection module 420 generates object type data indicating whether an object detected within a region comprises a logo object or a barcode object. In such an embodiment, logo regions are identified as a small to medium sized image that has distinct colors and text features. Barcode regions may be defined based on what is capable of being processed. For example, there are a discrete list of 1d and 2d barcode types that are valid for processing. The YOLO model being trained with a complete list of those types of barcodes could determine that it is a barcode region. In one embodiment, a barcode processing library including a list of barcodes types is implemented to determine whether a barcode may be successfully decoded.

Object processing module 430 processes the inspection region data for the inspection regions. In one embodiment, processing the inspection regions comprises comparing inspection regions across each page image in order to combine inspection regions. In this embodiment, object processing module 430 generates meta-data based on the combined inspection regions. For example, the meta-data may indicate each page at which an inspection region is located.

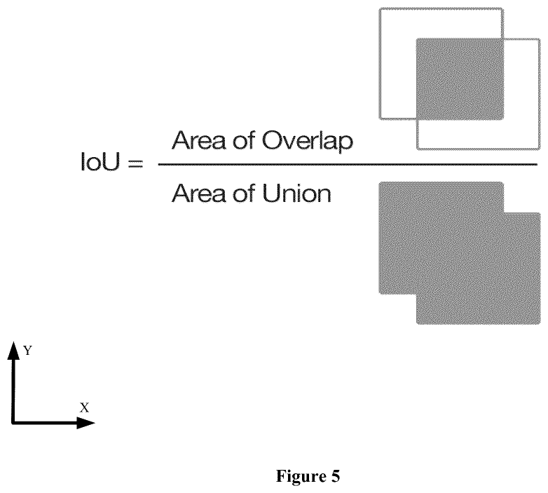

In a further embodiment, object processing module 430 implements a non-maxima suppression (NMS) and scale invariant feature transformation (SIFT) to aggregate and improve detection on object types across all of the page images. Thus, object processing module 430 combines page images having similar features (e.g., logos and barcodes). Combining the page images comprises combining inspection regions based on an intersection over union (IOU) process in which two regions are combined (e.g., via NMS) upon a determination that regions on separate page images belong to the same class and also have a high IOU and similar SIFT features. This process is performed in order to refine the inspection regions, which removes misdetections or wrongly labelled data resulting from the deep learning model inference. In yet a further embodiment, similarity is based on three components: location (e.g., IoU>0.5), labels (e.g., objects having the same print object types and SIFT features). FIG. 5 illustrates one embodiment of a process for determining similarity in which IoU=Area of Overlap/Area of Union.

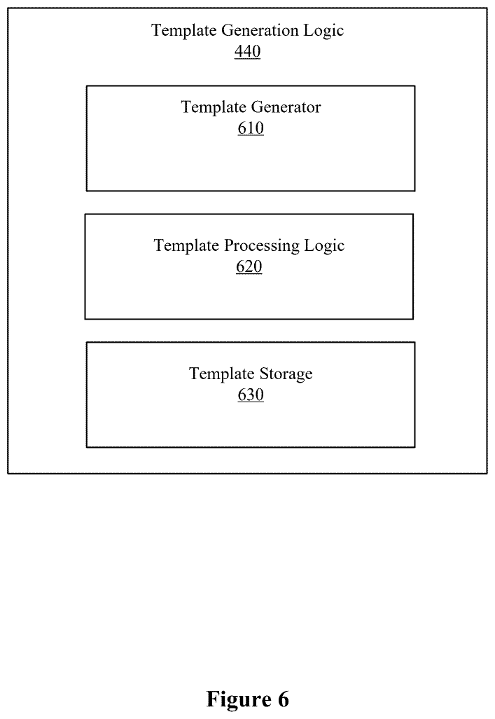

Referring back to FIG. 4, template generation module 420 also includes template generation logic 440 to generate the inspection templates. FIG. 6 illustrates one embodiment of template generation logic 440 including template generator 610. In one embodiment, template generator 610 analyzes each distinct inspection region detected at object detection module 420 and generates inspection templates based on an occurrence rate of the inspection regions. A resulting technical benefit includes improving inspection templates by identifying and including higher occurrence regions in the inspection templates and not including regions with lower occurrence that are of lesser concern.

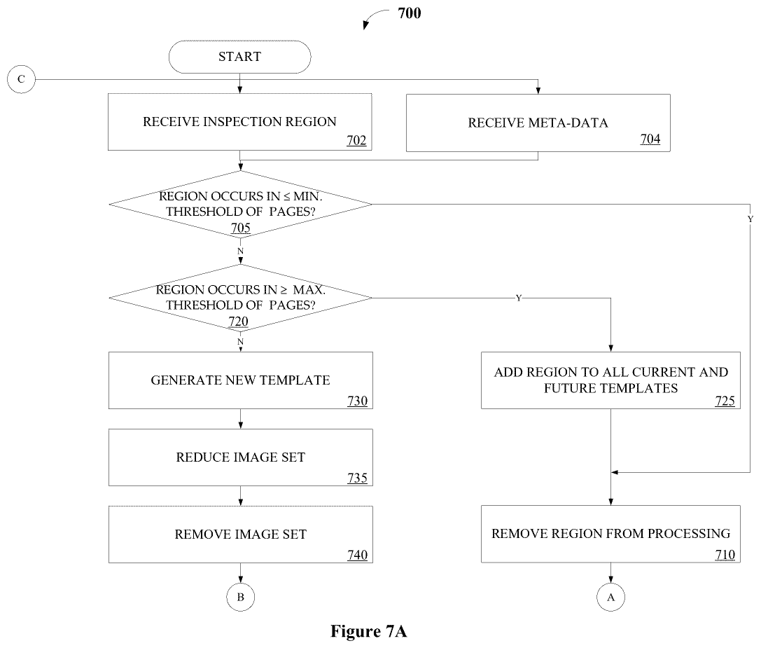

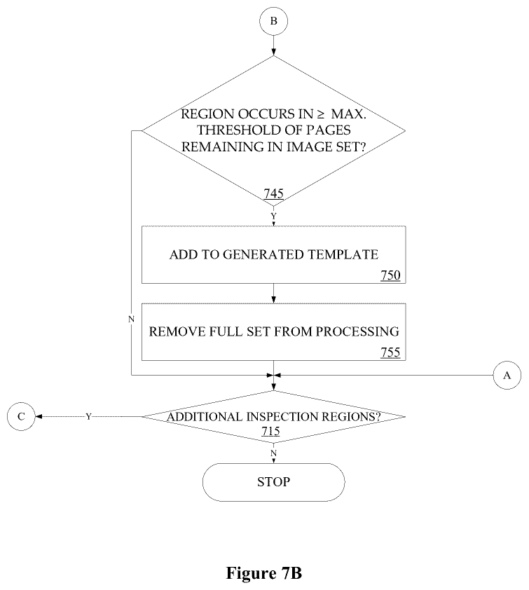

FIGS. 7A&7B is a flow diagram illustrating one embodiment of a process 700 for generating inspection templates. Process 700 may be performed by processing logic that may comprise hardware (e.g., circuitry, dedicated logic, programmable logic, etc.), software (such as instructions run on a processing device), or a combination thereof. The process 700 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-6 are not discussed or repeated here.

Process 700 begins at processing blocks 702 and 704 (FIG. 7A) where an inspection region (e.g., inspection region data) and the associated meta-data, respectively, are received. At decision block 705, a determination is made as to whether an inspection region occurs in less than or equal to a minimum threshold of pages (e.g., ≤2%) in the image set of page images. If not, the inspection region is removed from processing, processing block 710. At decision block 715 (FIG. 7B), a determination is made as to whether there are additional inspection regions to process. If not, process 700 has been completed. Otherwise, control is returned to processing block 702 where another inspection region is received.

Upon a determination at decision block 705 that the inspection region occurs in more than the minimum threshold of the pages, a determination is made as to whether the inspection region occurs in greater than or equal to a maximum threshold (e.g., ≥99%) of pages in the image set of page images, decision block 720. The inspection region is added to all current and future templates upon a determination that the inspection region occurs in greater than or equal to the maximum threshold, processing block 725, prior to control being returned to processing block 710 where the inspection region is removed from further processing.

However, a new template is generated upon a determination at decision block 720 that the inspection region does not occur in greater than or equal to the maximum threshold (e.g., the inspection region occurs between the minimum and maximum threshold of pages), processing block 730. At processing block 735, the image set is reduced to page images including the region. At processing block 740, the image set of page images including the inspection region is removed from top level processing. Thus, the image set of page images is associated with the newly generated template and no longer need to be processed in subsequent iterations of process 700.

Subsequently, a determination is made as to whether the inspection region occurs in greater than or equal to the maximum threshold of the page images in the reduced image set (e.g., remaining page images after removal of the inspection region image set), decision block 745 (FIG. 7B). If not, the inspection region is skipped, and control is forwarded to decision block 715 to determine whether there are additional inspection regions to process. Otherwise, the inspection region is added to the generated template, processing block 750. At processing block 755, the inspection region is removed from the processing of the full set of inspection regions. At decision block 715, a determination is again made as to whether additional inspection regions are available for processing.

Once generated, templates are stored in template storage 630 within template generation logic 440 (FIG. 6). In one embodiment, the associated boundaries and the print object types within the one or more inspection regions are stored with each inspection template.

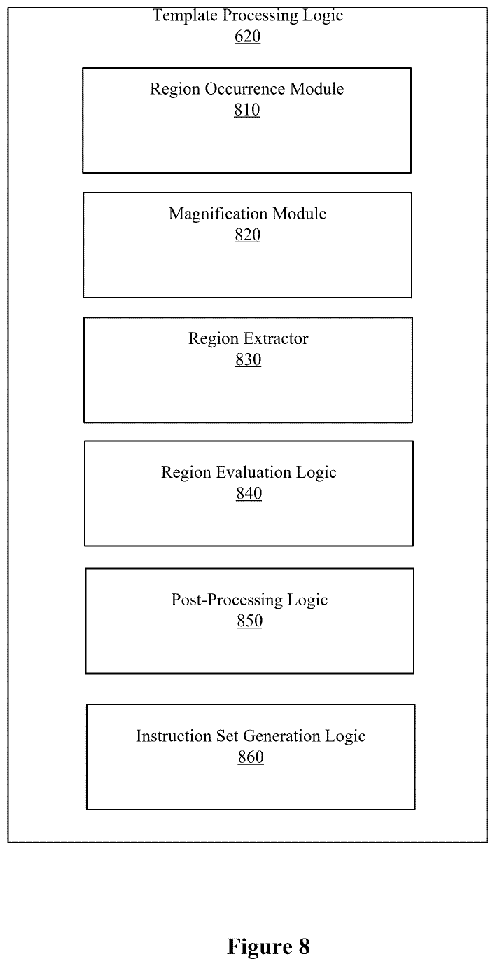

Template generation logic 440 also includes template processing logic 620 that is implemented to process page images having inspection regions within generated inspection templates. FIG. 8 illustrates one embodiment of template processing logic 620, which includes region occurrence module 810, magnification module 820, region extractor 830, region evaluation logic 840, post-processing logic 850 and instruction set generation logic 860.

Region occurrence module 810 determines a first page image in the print job at which each inspection region occurs. According to one embodiment, region occurrence module 810 uses the page identifier associated with a page image to identify an inspection region page and stores the page identifier in template storage 630 with the corresponding inspection region. In a further embodiment, the page identifier associated with each first inspection region page is included in an inspection production that is transmitted to inspection logic 195 sometime prior to printing the job and performing print job inspection at inspection system 190. A technical benefit resulting from including the page identifier in inspection templates is improving the inspection template's location details and accuracy.

Magnification module 820 facilitates the generation of high resolution bitmap images (e.g., 600 dpi) of page images at which inspection regions occur. In one embodiment, magnification module 820 transmits the page identifiers associated with inspection page images to interpreter module 212, which generates the high resolution page images. Region extractor 830 receives the high resolution page images and extracts the inspection regions from the images. A technical benefit resulting from generating high resolution page images includes more accurate detection and processing of inspection regions, especially in comparing the stored results to the scanned images to determine printed defects.

Region evaluation logic 840 receives the extracted inspection regions and evaluates each inspection region to determine a type of object within the inspection region (e.g., logo region or barcode region). Upon a determination that the inspection region is a barcode region, region evaluation logic 840 determines the barcode type (if possible), as well as configurable error thresholds.

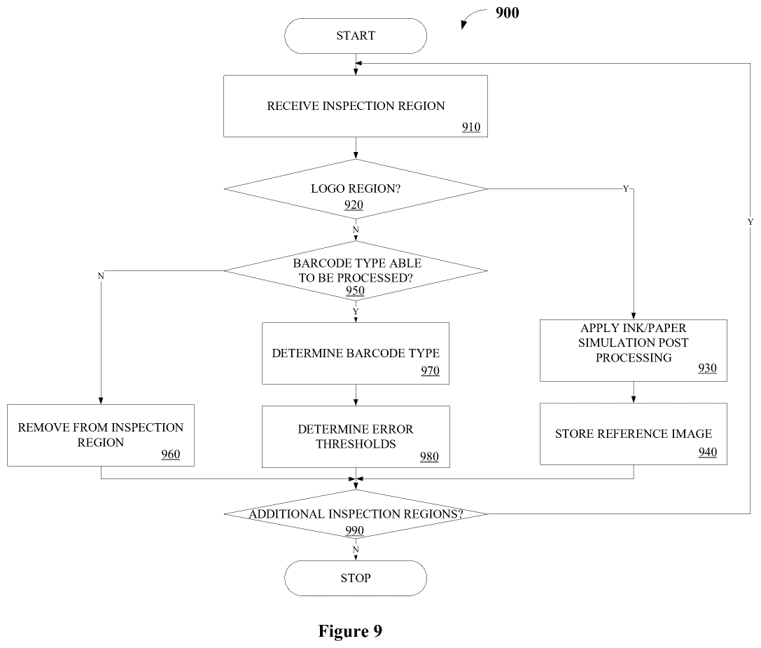

FIG. 9 is a flow diagram illustrating one embodiment of a process 900 for evaluating regions of interest. Process 900 may be performed by processing logic that may comprise hardware (e.g., circuitry, dedicated logic, programmable logic, etc.), software (such as instructions run on a processing device), or a combination thereof. The process 900 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-8 are not discussed or repeated here.

Process 900 begins at processing block 910 where an inspection region (e.g., inspection region data) is received. At decision block 920, a determination is made as to whether the inspection region is a logo region. In one embodiment, the region type is determined by comparing object type data received from object detection module 420 to the object in the inspection region to confirm that the type of inspection region. Upon a determination at decision block 920 that the region is a logo region, ink/paper simulation post processing is applied, processing block 930. In one embodiment, ink/paper simulation post processing comprises modeling color changes that occur due to color profiles being applied at printer 160. At processing block 940, a reference image of the logo is stored. At decision block 990, a determination is made as to whether there are additional inspection regions to be evaluated. If so, control is returned to decision block 910 where another inspection region is received. Otherwise process 900 has completed.

The inspection region is determined to be a barcode region upon a determination at decision block 920 that the inspection region is not a logo region. Accordingly, a determination is made at decision block 950 as to whether the barcode is a type that is able to be processed. If not, the barcode is removed from the inspection region, processing block 960, and control is forwarded to decision block 990 for a determination as to whether there are additional inspection regions to be evaluated.

Upon a determination at decision block 950 that the barcode type can be processed, the barcode type (e.g., 1D code, 2D code, postal code, etc.) is determined, processing block 970. At processing block 980, error thresholds are determined. An error threshold comprises a decode grade provided to various barcodes. For example, barcodes, such as postal codes, have ANSI standards that are required. Some of the error thresholds have to do with the geometry of the barcode and the allowable size variation. At decision block 990, a determination is again made as to whether there are additional inspection regions to be evaluated. As mentioned above, the process has been completed once there are no additional inspection regions to evaluate.

Referring back to FIG. 8, post-processing logic 850 also receives the high resolution page images to process the full images to conform to a layout supported by one or more image capturing devices (e.g., paper width, black roller, number of pixels, etc.) at inspection system 190. Additionally, post-processing logic 850 extracts meta parameters (e.g., paper length, N-up and scanning resolution) from the high resolution page images. Instruction set generation logic 860 generates an instruction set and reference image for each generated inspection template and stores the instruction set in template storage 630 (FIG. 6). In one embodiment, an inspection instruction set comprises a set of Extensible Markup Language (XML) instructions.

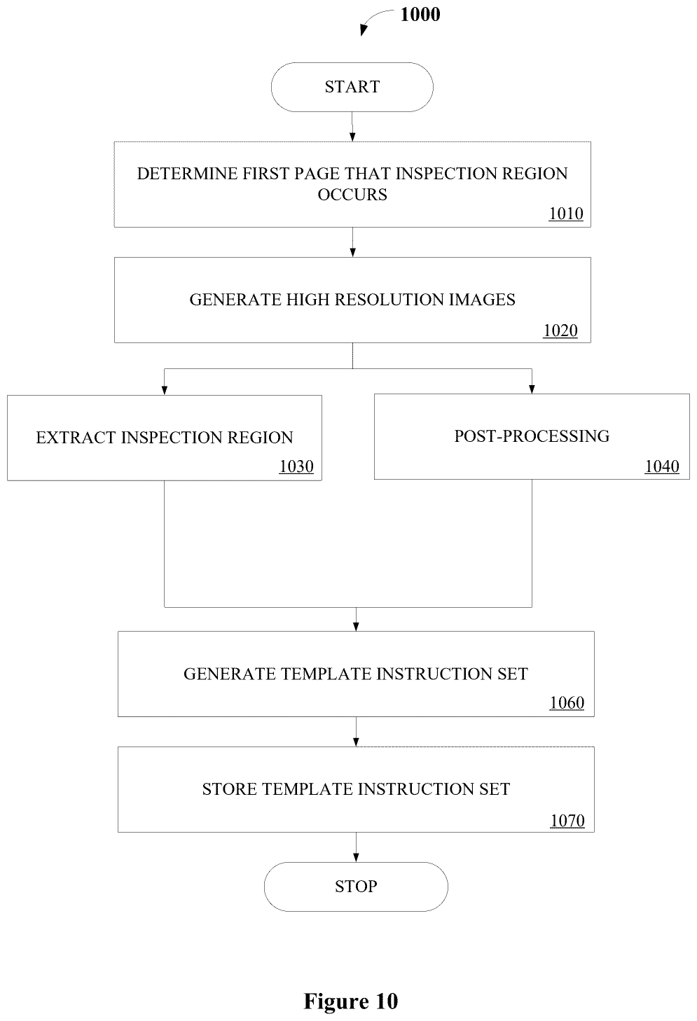

FIG. 10 is a flow diagram illustrating one embodiment of a process 1000 for generating an inspection template. Process 1000 may be performed by processing logic that may comprise hardware (e.g., circuitry, dedicated logic, programmable logic, etc.), software (such as instructions run on a processing device), or a combination thereof. The process 1000 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-9 are not discussed or repeated here.

Process 1000 begins at processing block 1010 where a first page is determined at which an inspection region occurs. At processing block 1020, high resolution images of page images that include the inspection region are generated. At processing blocks 1030 and 1040, the inspection region is extracted from the high resolution images and post-processing is performed, respectively. At processing block 1060, a template instruction set is generated based on the post-processing and the results of the evaluation. At processing block 1070, the template instruction set is stored in template storage 630.

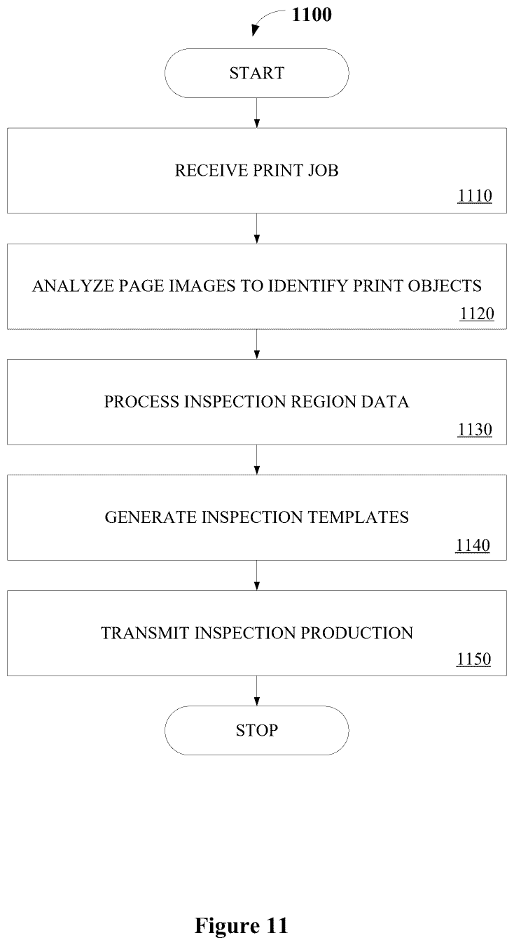

FIG. 11 is a flow diagram illustrating embodiments of a process 1100 for generating an inspection production including a plurality of inspection templates. Process 1100 may be performed by processing logic that may comprise hardware (e.g., circuitry, dedicated logic, programmable logic, etc.), software (such as instructions run on a processing device), or a combination thereof. The process 1100 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-10 are not discussed or repeated here.

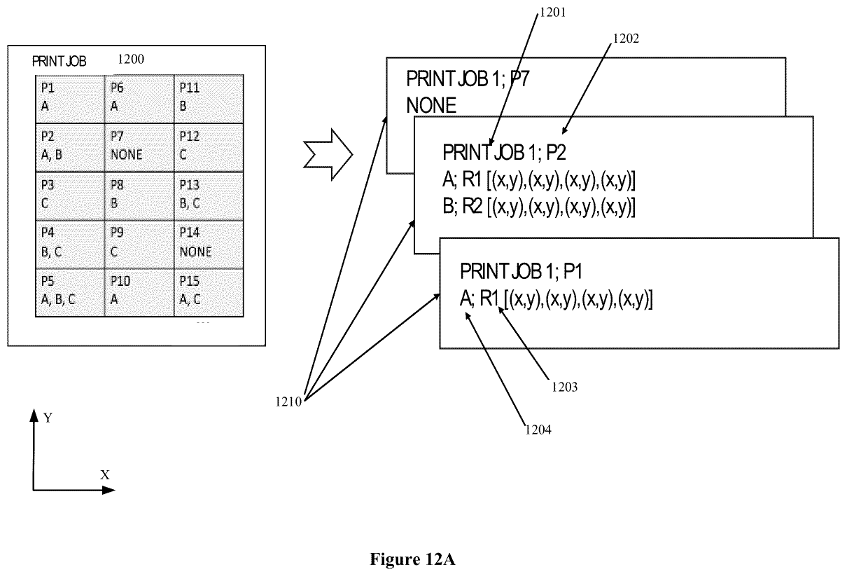

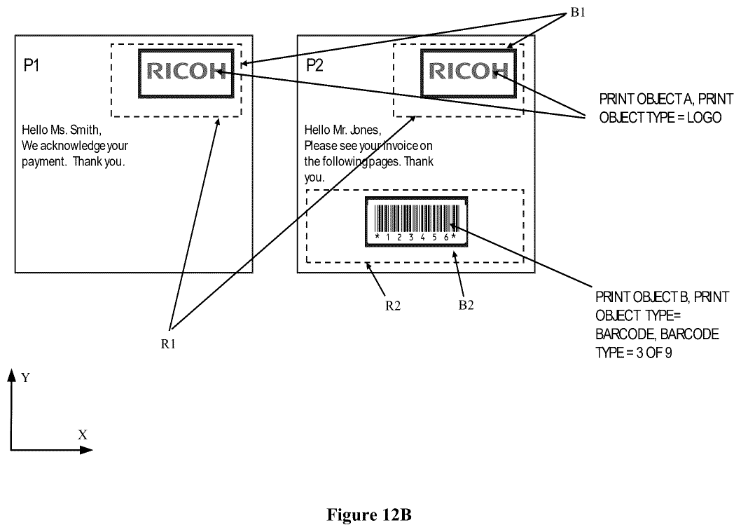

At process block 1110, a print job is received at print controller 140. FIG. 12A illustrates one embodiment of a print job 1200. As shown in FIG. 12A, print job 1200 includes a matrix of logical pages P1-P15. A logical page includes one or more print objects. For example, logical pages P1 and P2 each include object A. At processing block 1120, page images within the print job are analyzed to identify print objects. At processing block 1130, inspection region data is processed. At processing block 1140, inspection templates are generated for the print job, as discussed above. The inspection templates are combined to generate an inspection production. FIG. 12A also discloses an inspection production including inspection templates 1210 generated for pages P1, P2 and P7. Inspection templates 1210 include a production identifier 1201, a page identifier 1202, a region identifier 1203 including boundary coordinates and an object identifier 1204 that indicates an object type. Pages P1 and P2 each include objects A located at a region R1. Additionally, page P2 includes an object B at region R2

At processing block 1150, the inspection production is transmitted to inspection system 190. Sometime later, the print job data is printed to a print medium at printer 160 and print images are captured. Upon receiving or generating the captured print images, inspection system 190 uses the plurality of inspection templates within the inspection production to perform quality inspections of the captured print images of the printed print job data. FIG. 12B illustrates one embodiment of printed pages P1 and P2 that are inspected using generated inspection templates 1210. As shown in FIG. 12B, pages P1 and P2 each include object A, which is a logo print object type that is inspected at region R1 having an associated boundary B1. As discussed above, page P2 also includes object B, which is a barcode object type (e.g., barcode type=3 OF 9) that is inspected at region R2 having an associated boundary B2.

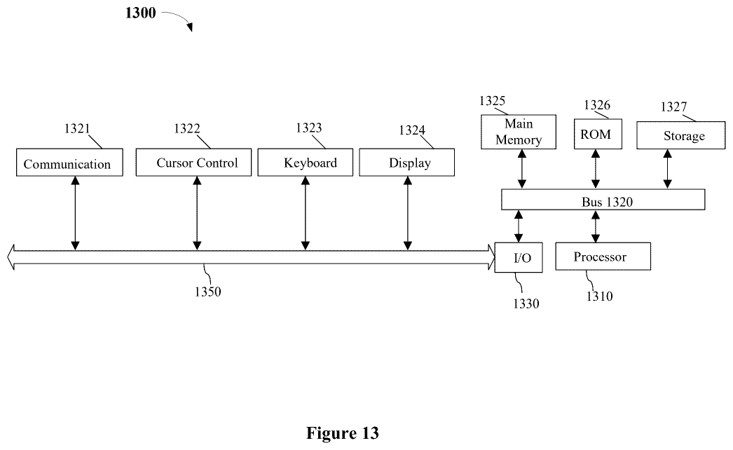

FIG. 13 illustrates a computer system 1300 on which host system 110, printing system 130, print controller 140 and/or inspection system 190 may be implemented. Computer system 1300 includes a system bus 1320 for communicating information, and a processor 1310 coupled to bus 1320 for processing information.

Computer system 1300 further comprises a random access memory (RAM) or other dynamic storage device 1327 (referred to herein as main memory), coupled to bus 1320 for storing information and instructions to be executed by processor 1310. Main memory 1325 also may be used for storing temporary variables or other intermediate information during execution of instructions by processor 1310. Computer system 1300 also may include a read only memory (ROM) and or other static storage device 1326 coupled to bus 1320 for storing static information and instructions used by processor 1310.

A data storage device 1327 such as a magnetic disk or optical disc and its corresponding drive may also be coupled to computer system 1300 for storing information and instructions. Computer system 1300 can also be coupled to a second I/O bus 1350 via an I/O interface 1330. A plurality of I/O devices may be coupled to I/O bus 1350, including a display device 1324, an input device (e.g., a keyboard 1323 (e.g., alphanumeric input device) and/or a cursor control device 1322). The communication device 1321 is for accessing other computers (servers or clients). The communication device 1321 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes at least one physical memory device to store inspection template generation logic and one or more processors coupled with the at least one physical memory device to execute the inspection template generation logic to receive one or more page images of a processed print job, analyze the page images to identify print objects and determine corresponding inspection regions in the corresponding page images at which the print objects are located and generate an inspection template including the inspection regions, wherein the inspection regions comprise regions to be inspected during document inspection of the printed print job.

Example 2 includes the subject matter of Example 1, wherein analyzing the page images further comprises determining boundaries of the inspection regions including coordinates within the corresponding page images.

Example 3 includes the subject matter of Examples 1 and 2, wherein analyzing the page images further comprises identifying one of a plurality of print object types for each of the identified print objects.

Example 4 includes the subject matter of Examples 1-3, wherein the plurality of print object types comprise a logo, a barcode, a control mark and an optical character recognition pattern.

Example 5 includes the subject matter of Examples 1-4, wherein the inspection template generation logic analyzes the print objects to determine print object type as one of a plurality of types of the barcode and includes the one of the plurality of barcode types in the inspection template.

Example 6 includes the subject matter of Examples 1-5, wherein the one or more inspection regions, the boundaries and the print object types within the one or more inspection regions are included in the inspection template.

Example 7 includes the subject matter of Examples 1-6, wherein the inspection template generation logic generates an inspection template based on an occurrence rate of the one or more inspection regions.

Example 8 includes the subject matter of Examples 1-7, wherein the inspection template generation logic comprises a trained neural network and the one or more processors execute the trained neural network to analyze the page images.

Example 9 includes the subject matter of Examples 1-8, wherein the inspection template generation logic further to transmit the inspection template.

Example 10 includes the subject matter of Examples 1-9, further comprising a printer to print the print job on a print medium.

Example 11 includes the subject matter of Examples 1-10, further comprising an inspection system to receive the inspection template and perform inspection of the one or more inspection regions in captured images of the printed print job using the inspection template.

Example 12 includes the subject matter of Examples 1-11, wherein the inspection template generation logic generates high resolution page images from the one or more page images and performs post-processing of the high resolution page images to extract meta parameters from the high resolution page images.

Some embodiments pertain to Example 13 that includes a method comprising to receiving one or more page images of a processed print job, analyzing the page images to identify print objects and determine corresponding inspection regions in the corresponding page images at which the print objects are located and generating an inspection template including the inspection regions, wherein the inspection regions comprise regions to be inspected during document inspection of the printed print job.

Example 14 includes the subject matter of Example 13, wherein analyzing the page images further comprises determining boundaries of the inspection regions including coordinates within the corresponding page images.

Example 15 includes the subject matter of Examples 13 and 14, wherein analyzing the page images further comprises identifying one of a plurality of print object types for each of the identified print objects.

Example 16 includes the subject matter of Examples 13-15, wherein the plurality of print object types comprise a logo, a barcode, a control mark and an optical character recognition pattern.

Some embodiments pertain to Example 17 that includes at least one computer readable medium having instructions stored thereon, which when executed by one or more processors, cause the processors to receive one or more page images of a processed print job, analyze the page images to identify print objects and determine corresponding inspection regions in the corresponding page images at which the print objects are located and generate an inspection template including the inspection regions, wherein the inspection regions comprise regions to be inspected during document inspection of the printed print job.

Example 18 includes the subject matter of Example 17, wherein analyzing the page images further comprises determining boundaries of the inspection regions including coordinates within the corresponding page images.

Example 19 includes the subject matter of Examples 17 and 18, wherein analyzing the page images further comprises identifying one of a plurality of print object types for each of the identified print objects.

Example 20 includes the subject matter of Examples 17-19, wherein the plurality of print object types comprise a logo, a barcode, a control mark and an optical character recognition pattern.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential.

What is claimed is:

1. A system comprising:
at least one physical memory device to store inspection template generation logic and
one or more processors coupled with the at least one physical memory device to execute the inspection template generation logic to:
receive one or more page images of a processed print job;
analyze the page images to identify print objects and determine corresponding inspection regions in the corresponding page images at which the print objects are located; and
generate an inspection template including the inspection regions, wherein the inspection regions comprise regions to be inspected during document inspection of the printed print job.

2. The system of claim 1, wherein analyzing the page images further comprises determining boundaries of the inspection regions including coordinates within the corresponding page images.

3. The system of claim 2, wherein analyzing the page images further comprises identifying one of a plurality of print object types for each of the identified print objects.

4. The system of claim 3, wherein the plurality of print object types comprise a logo, a barcode, a control mark and an optical character recognition pattern.

5. The system of claim 4, wherein the inspection template generation logic analyzes the print objects to determine print object type as one of a plurality of types of the barcode and includes the one of the plurality of barcode types in the inspection template.

6. The system of claim 4, wherein the one or more inspection regions, the boundaries and the print object types within the one or more inspection regions are included in the inspection template.

7. The system of claim 1, wherein the inspection template generation logic generates an inspection template based on an occurrence rate of the one or more inspection regions.

8. The system of claim 2, wherein the inspection template generation logic comprises a trained neural network and the one or more processors execute the trained neural network to analyze the page images.

9. The system of claim 1, wherein the inspection template generation logic further to transmit the inspection template.

10. The system of claim 9, further comprising a printer to print the print job on a print medium.

11. The system of claim 10, further comprising an inspection system to receive the inspection template and perform inspection of the one or more inspection regions in captured images of the printed print job using the inspection template.

12. The system of claim 1, wherein the inspection template generation logic generates high resolution page images from the one or more page images and performs post-processing of the high resolution page images to extract meta parameters from the high resolution page images.

13. A method comprising:
receiving one or more page images of a processed print job;
analyzing the page images to identify print objects and determine corresponding inspection regions in the corresponding page images at which the print objects are located; and
generating an inspection template including the inspection regions, wherein the inspection regions comprise regions to be inspected during document inspection of the printed print job.

14. The method of claim 13, wherein analyzing the page images further comprises determining boundaries of the inspection regions including coordinates within the corresponding page images.

15. The method of claim 14, wherein analyzing the page images further comprises identifying one of a plurality of print object types for each of the identified print objects.

16. The method of claim 15, wherein the plurality of print object types comprise a logo, a barcode, a control mark and an optical character recognition pattern.

17. At least one computer readable medium having instructions stored thereon, which when executed by one or more processors, cause the processors to:
receive one or more page images of a processed print job;
analyze the page images to identify print objects and determine corresponding inspection regions in the corresponding page images at which the print objects are located; and
generate an inspection template including the inspection regions, wherein the inspection regions comprise regions to be inspected during document inspection of the printed print job.

18. The computer readable medium of claim 17, wherein analyzing the page images further comprises determining boundaries of the inspection regions including coordinates within the corresponding page images.

19. The computer readable medium of claim 18, wherein analyzing the page images further comprises identifying one of a plurality of print object types for each of the identified print objects.

20. The computer readable medium of claim 19, wherein the plurality of print object types comprise a logo, a barcode, a control mark and an optical character recognition pattern.
